(19) United States
(12) Patent Application Publication
(10) Pub. No.: US 2026/0084487 A1
(43) Pub. Date: Mar. 26, 2026

(54) CONTROL METHOD OF HEAT PUMP SYSTEM FOR VEHICLE

(71) Applicants: HYUNDAI MOTOR COMPANY, Seoul (KR); Kia Corporation, Seoul (KR)

(72) Inventors: Jeawan KIM, Hwaseong-si (KR); Hochan AN, Hwaseong-si (KR); Soonbeom KWON, Hwaseong-si (KR); Yeon Ho KIM, Hwaseong-si (KR); Jeong Keun KIM, Hwaseong-si (KR); Gwi Taek KIM, Hwaseong-si (KR); Hoyoung JEONG, Hwaseong-si (KR); Man Hee PARK, Hwaseong-si (KR); Yeong Jun KIM, Hwaseong-si (KR); Jae Yeon KIM, Hwaseong-si (KR); Dong Jun SHIM, Hwaseong-si (KR)

(73) Assignees: HYUNDAI MOTOR COMPANY, Seoul (KR); Kia Corporation, Seoul (KR)

(21) Appl. No.: 19/236,315

(22) Filed: Jun. 12, 2025

(30) Foreign Application Priority Data
Sep. 23, 2024 (KR) 10-2024-0128271

(51) Int. Cl. B60H 1/00; F25B 30/02

(52) U.S. Cl. CPC B60H 1/00899; B60H 1/00807; F25B 30/02

(57) ABSTRACT

A control method of a heat pump system for a vehicle, which is applied with a gas injection device, can improve the performance and efficiency of the entire system by efficiently controlling the operation of the gas injection device depending on conditions when heating the vehicle interior.

### CROSS-REFERENCE TO RELATED APPLICATION

The present application claims priority to and the benefit of Korean Patent Application No. 10-2024-0128271 filed with the Korean Intellectual Property Office on Sep. 23, 2024, the entire contents of which is incorporated herein by reference.

### BACKGROUND OF THE INVENTION

### Field of the Present Disclosure

The present disclosure relates to a control method of a heat pump system for a vehicle, and more particularly, the present disclosure relates to a control method of a heat pump system for a vehicle, which is applied with a gas injection device, capable of improving the performance and efficiency of the entire system by efficiently controlling the operation of the gas injection device depending on conditions when heating the vehicle interior.

### Description of the Related Art

Generally, an air conditioning system for a vehicle includes an air conditioner unit circulating a refrigerant to heat or cool an interior of the vehicle.

The air conditioner unit, which is to maintain the interior of the vehicle at an appropriate temperature regardless of a change in an external temperature to maintain a comfortable internal environment, is configured to heat or cool the interior of the vehicle by heat-exchange by a condenser and an evaporator in a process in which a refrigerant discharged by driving of a compressor is circulated back to the compressor through the condenser, a receiver drier, an expansion valve, and the evaporator.

That is, the air conditioner unit lowers a temperature and a humidity of the interior by condensing a high-temperature high-pressure gas-phase refrigerant compressed from the compressor by the condenser, passing the refrigerant through the receiver drier and the expansion valve, and then evaporating the refrigerant in the evaporator in a cooling mode in summer.

Meanwhile, recently, in accordance with a continuous increase in interest in energy efficiency and an environmental pollution problem, the development of an environment-friendly vehicle configured for substantially substituting for an internal combustion engine vehicle is required, and the environment-friendly vehicle is classified into an electric vehicle driven using a fuel cell or electricity as a power source and a hybrid vehicle driven using an engine and a battery.

In the electric vehicle or the hybrid vehicle among these environment-friendly vehicles, a separate heater is not used unlike an air conditioner of a general vehicle, and an air conditioner used in the environment-friendly vehicle is generally called a heat pump system.

Meanwhile, the electric vehicle driven by the power source of the fuel cell generates driving force by converting chemical reaction energy between oxygen and hydrogen into electrical energy. In the present process, thermal energy is generated by a chemical reaction in a fuel cell. Therefore, it is necessary in securing performance of the fuel cell to effectively remove generated heat.

Furthermore, the hybrid vehicle generates driving force by driving a motor using electricity supplied from the fuel cell described above or an electrical battery, together with an engine operated by a general fuel. Therefore, heat generated from the fuel cell or the battery and the motor should be effectively removed to secure performance of the motor.

However, in the heat pump system according to the above conventional technology, as the external temperature decreases, the heating capacity of the heat pump system decreases, which lowers the heating performance and efficiency, and an electric heater may be used to supplement the insufficient heating performance, which includes the disadvantage of reducing the overall driving distance due to increased power consumption.

To address these issues, gas injection devices have recently been applied to increase the flow rate of refrigerant, reduce the power consumption of the compressor, and minimize the use of electric heaters.

However, in a conventional heat pump system, the gas injection device is controlled to simply operate or not operate in the heating mode of the vehicle interior, so there is a problem that it is difficult to operate the gas injection device under optimal conditions.

Furthermore, conventional heat pump systems have problems such as a decrease in the durability and stability of the compressor due to liquid refrigerant flowing into the compressor from the gas injection device when the gas injection device is operated under unsuitable conditions.

Accordingly, a control method of a heat pump system to efficiently operate a gas injection device under a more optimal condition is required.

The above information included in the present Background section is only for enhancement of understanding of the background of the disclosure, and therefore it may include information that does not form the related art which is already known in the present country to a person of ordinary skill in the art.

### SUMMARY OF THE INVENTION

The present disclosure attempts to provide a control method of a heat pump system for a vehicle, which is applied with a gas injection device, configured for improve the performance and efficiency of the entire system by efficiently controlling the operation of the gas injection device depending on conditions when heating the vehicle interior.

Furthermore, the present disclosure attempts to provide a control method of a heat pump system for a vehicle configured for reduce the air conditioning power consumption and increase the travel distance at the same time by first performing a normal heating mode in which the gas injection device is not operated, when heating the vehicle interior, and then performing the gas injection heating mode by determining whether the operation of the gas injection device is possible.

A control method of a heat pump system for a vehicle may include operating, by a controller, a normal heating mode when a user operates a heat pump system for heating a vehicle interior, determining, by the controller, whether an operation of a gas injection heating mode is possible based on data detected from a data detecting unit, when it is determined that the operation of the gas injection heating mode is possible (i.e., the condition is satisfied) in the determining of whether an operation of the gas injection heating mode is possible, operating, by the controller, the gas injection heating mode by operating a gas injection device, checking, by the controller, a vehicle interior target temperature, and setting a target discharge air temperature based on the data detected from the data detecting unit, determining, by the controller, whether a vehicle interior air discharge temperature is lower than the target discharge air temperature, and increasing, by the controller, an RPM (i.e., revolution per minute) of a compressor, when it is determined that the vehicle interior air discharge temperature is lower than the target discharge air temperature (i.e., the condition is satisfied) in the determining of whether the vehicle interior air discharge temperature is lower than the target discharge air temperature.

In the determining of whether the operation of the gas injection heating mode is possible, the controller may be configured to perform determining whether a first condition that an ambient air temperature is higher than a predetermined temperature is satisfied, and determine whether a second condition that a normal heating mode operation time is longer than a predetermined particular time is satisfied.

The controller may be configured to determine that the operation of the gas injection heating mode is possible when the first condition and the second condition are satisfied at the same time, and determine that the operation of the gas injection heating mode is impossible when any one of the first condition and the second condition is not satisfied.

In the determining of whether the operation of the gas injection heating mode is possible, the control method may proceed back to perform the operating of the normal heating mode, when it is determined that the operation of the gas injection heating mode is impossible (i.e., when the condition is not satisfied).

In the determining of whether the vehicle interior air discharge temperature is lower than the target discharge air temperature, the controller may be configured to perform the decreasing the RPM (i.e., revolution per minute) of the compressor when it is determined that the vehicle interior air discharge temperature is higher than the target discharge air temperature (i.e., when the condition is not satisfied).

The control method may further include determining, by the controller, whether a compressor discharge pressure or a condenser discharge temperature is higher than a first predetermined value based on the data detected from the data detecting unit, and increasing, by the controller, an opening of a second expansion valve when it is determined that the compressor discharge pressure or the condenser discharge temperature is higher than the first predetermined value (i.e., the condition is satisfied).

In the determining of whether the compressor discharge pressure or the condenser discharge temperature is higher than the first predetermined value, the controller may be configured to perform the decreasing of the opening of the second expansion valve when it is determined that the compressor discharge pressure or the condenser discharge temperature is lower than the first predetermined value (i.e., when the condition is not satisfied).

The control method may further include determining, by the controller, whether a value obtained by dividing a difference value obtained by subtracting a compressor inlet pressure from an injection pressure by a difference value obtained by subtracting the compressor inlet pressure from the compressor discharge pressure is higher than a second predetermined value based on the data detected from the data detecting unit, and Increasing, by the controller, an opening of a first expansion valve and terminating a control, when it is determined that the value obtained by dividing a difference value obtained by subtracting the compressor inlet pressure from the injection pressure by the difference value obtained by subtracting the compressor inlet pressure from the compressor discharge pressure is higher than the second predetermined value (i.e., the condition is satisfied).

In the determining of whether a value obtained by dividing the difference value obtained by subtracting the compressor inlet pressure from the injection pressure by the difference value obtained by subtracting the compressor inlet pressure from the compressor discharge pressure is higher than the second predetermined value, the controller may be configured to perform the decreasing the opening of the first expansion valve and terminate a control, when it is determined that the value obtained by dividing the difference value obtained by subtracting the compressor inlet pressure from the injection pressure by the difference value obtained by subtracting the compressor inlet pressure from the compressor discharge pressure is lower than the second predetermined value (i.e., when the condition is not satisfied).

The data detecting unit may include a first pressure sensor configured for measuring a pressure (a compressor discharge pressure) of a refrigerant discharged from the compressor, a second pressure sensor configured for measuring a pressure (a compressor inlet pressure) of the refrigerant introduced into the compressor, a third pressure sensor configured for measuring a pressure (an injection pressure) of the refrigerant introduced from the gas injection device into the compressor, a refrigerant temperature sensor configured for measuring a temperature of the refrigerant discharged from a condenser, a vehicle interior temperature sensor configured for measuring a temperature of the vehicle interior, and a discharge air temperature sensor configured for measuring a temperature of the air discharged into the vehicle interior.

The controller is electrically connected to the heat pump system, and the heat pump system may include the compressor configured to compress an introduced refrigerant, a condenser connected to the compressor through a refrigerant line, and configured to condense the introduced refrigerant, a first expansion valve connected to the condenser through the refrigerant line, and configured to selectively expand the introduced refrigerant, an evaporator connected to the first expansion valve through the refrigerant line, and configured to evaporate the introduced refrigerant, and the gas injection device disposed on the refrigerant line between the condenser and the first expansion valve, and configured to selectively expand the refrigerant supplied from the condenser and flow the expanded refrigerant and selectively supply a partial refrigerant among the supplied refrigerant to the compressor to increase a flow rate of the refrigerant circulating the refrigerant line.

The gas injection device may include a gas-liquid separator configured to separate an internally introduced refrigerant into a gaseous refrigerant and a liquid refrigerant and selectively discharge the separated refrigerant, a second expansion valve disposed on the refrigerant line between the condenser and the gas-liquid separator, and configured to selectively expand the introduced refrigerant, and a supply line connecting the compressor and the gas-liquid separator, and configured to selectively supply the gaseous refrigerant from the gas-liquid separator to the compressor.

As described above, according to a control method of a heat pump system for a vehicle according to an exemplary embodiment of the present disclosure, a control method of a heat pump system for a vehicle, which is applied with a gas injection device, may improve the performance and efficiency of the entire system by efficiently controlling the operation of the gas injection device depending on conditions when heating the vehicle interior.

Furthermore, the present disclosure can reduce the air conditioning power consumption and increase the travel distance at the same time, by first performing a normal heating mode in which the gas injection device is not operated, when heating the vehicle interior, and then performing the gas injection heating mode by determining whether the operation of the gas injection device is possible.

Furthermore, the present disclosure can prevent the liquid refrigerant remaining in the gas injection device from being introduced into the compressor in advance by controlling the gas injection device to operate only in the optimal condition when heating the vehicle interior, improving the durability and stability of the compressor.

### BRIEF DESCRIPTION OF THE DRAWINGS

FIG. 1 is a block diagram of a heat pump system to which a control method of a heat pump system for a vehicle according to an exemplary embodiment of the present disclosure is applied.

FIG. 2 is a block diagram showing a heat pump system control apparatus to which a control method of a heat pump system for a vehicle according to an exemplary embodiment of the present disclosure is applied.

FIG. 3 is a control flowchart for explaining a control method of a heat pump system for a vehicle according to an exemplary embodiment of the present disclosure.

### DETAILED DESCRIPTION OF THE EMBODIMENTS

An exemplary embodiment of the present disclosure will hereinafter be described in detail with reference to the accompanying drawings.

Exemplary embodiments included in the present specification and the constructions depicted in the drawings are only the exemplary embodiments of the present disclosure, and do not cover the entire scope of the present disclosure. Therefore, it will be understood that there may be various equivalents and variations at the time of the application of this specification.

To clarify the present disclosure, portions that are not related to the description will be omitted, and the same elements or equivalents are referred to with the same reference numerals throughout the specification.

Also, the size and thickness of each element are arbitrarily shown in the drawings, but the present disclosure is not necessarily limited thereto, and in the drawings, the thickness of layers, films, panels, regions, etc., are exaggerated for clarity.

In addition, unless explicitly described to the contrary, the word “comprise” and variations such as “comprises” or “comprising”, will be understood to imply the inclusion of stated elements but not the exclusion of any other elements.

Furthermore, each of terms, such as “. . . unit”, “. . . means”, “. . . portions”, “. . . part”, and “. . . member” described in the specification, mean a unit of a comprehensive element that performs at least one function or operation.

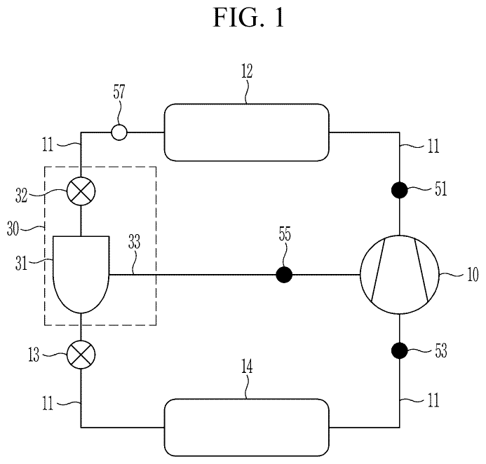

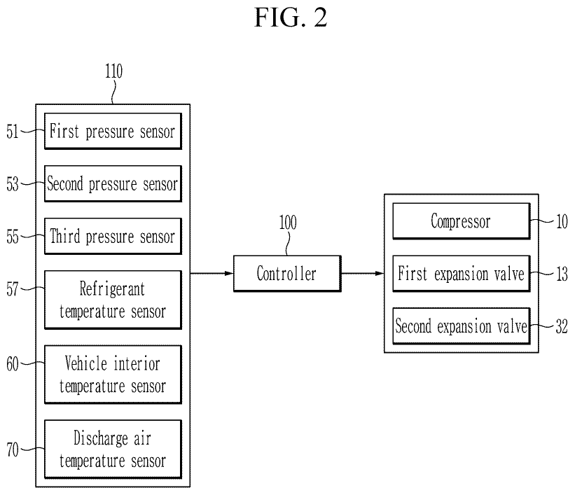

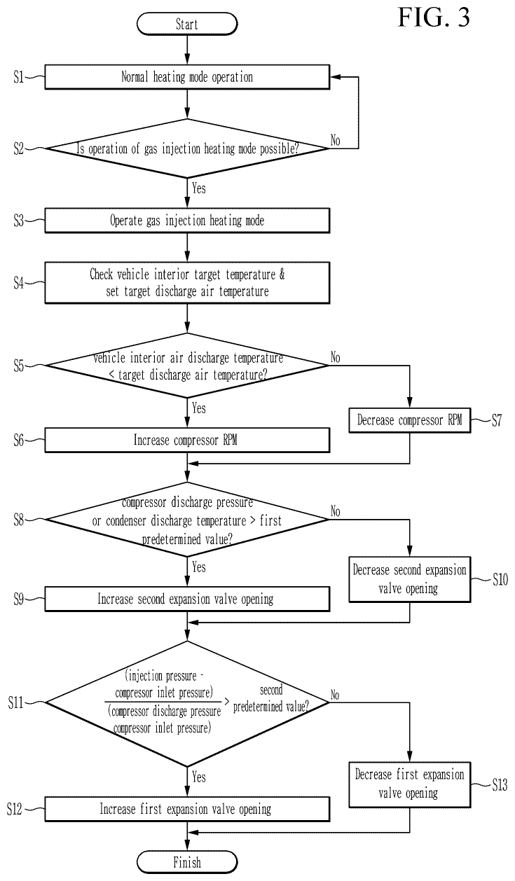

FIG. 1 is a block diagram of a heat pump system for a vehicle according to an exemplary embodiment of the present disclosure, and FIG. 2 is a block diagram showing a heat pump system control apparatus to which a control method of a heat pump system for a vehicle according to an exemplary embodiment of the present disclosure is applied, and FIG. 3 is a control flowchart for explaining a control method of a heat pump system for a vehicle according to an exemplary embodiment of the present disclosure.

Referring to the drawings, a control method of a heat pump system for a vehicle according to an exemplary embodiment of the present disclosure may be controlled by a controller 100, and may be applied to an electric vehicle or hybrid vehicle to which the heat pump system is applied.

The heat pump system may be controlled by a control apparatus, and the control apparatus may include the controller 100 and data detecting unit 110.

Here, the controller 100 including a processor may be electrically connected to the heat pump system.

As shown in FIG. 1, in an exemplary embodiment of the present disclosure, the heat pump system may include a compressor 10, a condenser 12, a first expansion valve 13, an evaporator 14, and a gas injection device 30.

First, the compressor 10 may compress an introduced refrigerant. The condenser 12 may be connected to the compressor 10 through a refrigerant line 11. The condenser 12 may condense the introduced refrigerant.

The first expansion valve 13 may be connected to the condenser 12 through the refrigerant line 11. The first expansion valve 13 may selectively expand the introduced refrigerant.

In an exemplary embodiment of the present disclosure, the evaporator 14 may be connected to the first expansion valve 13 through the refrigerant line 11, and may be connected to the compressor 10 through the refrigerant line 11. The evaporator 14 may evaporate the introduced refrigerant.

In addition, the gas injection device 30 may be disposed on the refrigerant line 11 between the condenser 12 and the first expansion valve 13.

The gas injection device 30 may selectively expand the refrigerant supplied from the condenser 12 and flow the expanded refrigerant, and may selectively supply a partial refrigerant among the supplied refrigerant to the compressor 10 to increase a flow rate of the refrigerant circulating the refrigerant line 11.

Here, the gas injection device 30 may include a gas-liquid separator 31, a second expansion valve 32, and a supply line 33.

The gas-liquid separator 31 may separate an internally introduced refrigerant into a gaseous refrigerant and a liquid refrigerant and selectively discharge the separated refrigerant.

The second expansion valve 32 may be disposed on the refrigerant line 11 between the condenser 12 and the gas-liquid separator. The second expansion valve 32 may selectively expand the introduced refrigerant.

In addition, the supply line 33 may connect the compressor 10 and the gas-liquid separator 31. When the expanded refrigerant is supplied to the gas-liquid separator 31, the supply line 33 may selectively supply the gaseous refrigerant from the gas-liquid separator 31 to the compressor 10.

That is, the supply line 33 may connect the gas-liquid separator 31 and the compressor 10 so that the gaseous refrigerant separated at the gas-liquid separator 31 may be selectively introduced into the compressor 10.

In an exemplary embodiment of the present disclosure, the data detecting unit 110 may detect data for the controller 100 to control an operation of the heat pump system.

The data detected by the data detecting unit 110 may be transferred to the controller 100. The data detecting unit 110 may include a first pressure sensor 51, a second pressure sensor 53, a third pressure sensor 55, a refrigerant temperature sensor 57, a vehicle interior temperature sensor 60, and a discharge air temperature sensor 70.

First, the first pressure sensor 51 may be disposed on the refrigerant line 11 between the compressor 10 and the condenser 12. The first pressure sensor 51 may measure a compressor discharge pressure, which is a pressure of the refrigerant discharged from the compressor 10.

That is, the first pressure sensor 51 may measure the compressor discharge pressure, and may transfer relevant signals to the controller 100.

The second pressure sensor 53 may be disposed on the refrigerant line 11 between the evaporator 14 and the compressor 10. The second pressure sensor 53 may measure a compressor inlet pressure, which is the pressure of the refrigerant introduced into the compressor 10.

That is, the second pressure sensor 53 may measure the compressor inlet pressure, and may transfer relevant signals to the controller 100.

In an exemplary embodiment of the present disclosure, the third pressure sensor 55 may be disposed on the supply line 33. The third pressure sensor 55 may measure an injection pressure, which is the pressure of the refrigerant introduced into the compressor 10 from the gas injection device 30.

That is, the third pressure sensor 55 may measure the injection pressure, and may transfer relevant signals to the controller 100.

The refrigerant temperature sensor 57 may be disposed on the refrigerant line 11 between the condenser 12 and the second expansion valve 32. The refrigerant temperature sensor 57 may measure a temperature (a condenser discharge temperature) of the refrigerant discharged from the condenser 12.

Accordingly, the refrigerant temperature sensor 57 may measure the condenser discharge temperature, and may transfer relevant signals to the controller 100.

In an exemplary embodiment of the present disclosure, the vehicle interior temperature sensor 60 may be disposed in the vehicle interior. It may measure a temperature of the vehicle interior of the vehicle interior temperature sensor 60, and may transfer relevant signals to the controller 100.

Furthermore, the discharge air temperature sensor 70 may be disposed at a position inside a Heating, Ventilation, and Air Conditioning (HVAC) module where the air is discharged into the vehicle interior. The discharge air temperature sensor 70 may measure a temperature of the air discharged into the vehicle interior, and may transfer relevant signals to the controller 100.

Accordingly, in a control method of a heat pump system for a vehicle according to an exemplary embodiment of the present disclosure, the controller 100 may improve the performance and efficiency of the entire system, by efficiently controlling an operation of the gas injection device 30 depending on conditions, when heating the vehicle interior, based on data detected by the data detecting unit 110.

Furthermore, in a control method of the heat pump system, the controller 100 can reduce the air conditioning power consumption and increase the travel distance at the same time, by first performing a normal heating mode in which the gas injection device 30 is not operated, when heating the vehicle interior, and then performing a gas injection heating mode by determining whether the operation of the gas injection device 30 is possible, based on data detected by the data detecting unit 110.

For such a purpose, as shown in FIG. 3, at step S1, in a control method of a heat pump system for a vehicle according to an exemplary embodiment of the present disclosure, when a user operates the heat pump system for heating the vehicle interior, the controller 100 may operate the normal heating mode in which the gas injection device 30 is not operated.

Accordingly, at step S2, the controller 100 may be configured to determine whether an operation of the gas injection heating mode is possible based on data detected from the data detecting unit 110.

Here, the controller 100 may perform, respectively, determining whether a first condition that an ambient air temperature is higher than predetermined specific temperature is satisfied, and determining whether a second condition that the normal heating mode operation time is longer than predetermined time is satisfied.

In more detail, the controller 100 may be configured to determine that an operation of the gas injection heating mode is possible when the first condition and the second condition are satisfied at the same time.

That is, at the step S2 of determining whether the operation of the gas injection heating mode is possible, when the first condition and the second condition are satisfied at the same time and it is determined that the operation of the gas injection heating mode is possible (i.e., the condition is satisfied), the controller 100 may operate the gas injection device 30 to operate the gas injection heating mode, at step S3.

In the instant case, in the gas injection device 30, the second expansion valve 32 may expand the refrigerant supplied from the condenser 12 and supply the expanded refrigerant to the gas-liquid separator 31.

Accordingly, the gas-liquid separator 31 may supply the gaseous refrigerant among the supplied refrigerant to the compressor 10 through the supply line 33, to increase the flow rate of the refrigerant circulating the refrigerant line 11.

To the contrary, at the step S2 of determining whether the operation of the gas injection heating mode is possible, when it is determined that the operation of the gas injection heating mode is impossible (i.e., when the condition is not satisfied), the controller 100 may proceed back to the step S1 of operating the normal heating mode, and repeatedly perform the above-described steps.

That is, the controller 100 may be configured to determine that the operation of the gas injection heating mode is impossible when any one of the first condition and the second condition is not satisfied. Thereafter, the controller 100 may repeatedly perform the step S1 and the step S2 described above.

Meanwhile, when the gas injection heating mode is operated by operating the gas injection device 30, at step S4, the controller 100 may check a vehicle interior target temperature set by the user, and may set a target discharge air temperature based on data detected from the data detecting unit 110.

Here, the target discharge air temperature may be set by comparing the vehicle interior target temperature set by the user with the temperature of the vehicle interior output from the vehicle interior temperature sensor 60.

When the step S4 is completed, the controller 100 may be configured to determine whether a vehicle interior air discharge temperature output from the discharge air temperature sensor 70 is lower than the target discharge air temperature, at step S5.

At the step S5 of determining whether the vehicle interior air discharge temperature is lower than the target discharge air temperature, when it is determined that the vehicle interior air discharge temperature is lower than the target discharge air temperature (i.e., the condition is satisfied), the controller 100 may increase an RPM (i.e., revolution per minute) of the compressor 10, at step S6.

To the contrary, at the step S5 of determining whether the vehicle interior air discharge temperature is lower than the target discharge air temperature, when it is determined that the vehicle interior air discharge temperature is higher than the target discharge air temperature (i.e., when the condition is not satisfied), the controller 100 may decrease the RPM (i.e., revolution per minute) of the compressor 10, at step S7.

When the step S6 or the step S7 is completed, the controller 100 may be configured to determine whether the compressor discharge pressure or the condenser discharge temperature is higher than a first predetermined value based on the data detected from the data detecting unit 110, at step S8.

Here, the compressor discharge pressure may be output from the first pressure sensor 51 to the controller 100, and the condenser discharge temperature may be output from the refrigerant temperature sensor 57 to the controller 100.

When it is determined at the step S8 that the compressor discharge pressure or the condenser discharge temperature is higher than the first predetermined value (i.e., the condition is satisfied), the controller 100 may increase an opening of the second expansion valve 32, at step S9.

To the contrary, when it is determined at the step S8 that the compressor discharge pressure or the condenser discharge temperature is lower than the first predetermined value (i.e., when the condition is not satisfied), the controller 100 may decrease the opening of the second expansion valve 32, at step S10.

When the step S9 or the step S10 is completed, the controller 100 may determine, based on data detected from the data detecting unit 110, whether a value obtained by dividing a difference value obtained by subtracting the compressor inlet pressure output from the second pressure sensor 53 from the injection pressure output from the third pressure sensor 55 by a difference value obtained by subtracting the compressor inlet pressure from the compressor discharge pressure is higher than a second predetermined value, at step S11.

When it is determined at the step S11 that a value obtained by dividing a difference value obtained by subtracting the compressor inlet pressure from the injection pressure by the difference value obtained by subtracting the compressor inlet pressure from the compressor discharge pressure is higher than the second predetermined value (i.e., the condition is satisfied), the controller 100 may increase an opening of the first expansion valve 13 and terminate a control, at step S12.

To the contrary, at the step S11 of determining whether the value obtained by dividing the difference value obtained by subtracting the compressor inlet pressure from the injection pressure by the difference value obtained by subtracting the compressor inlet pressure from the compressor discharge pressure is higher than the second predetermined value, when it is determined that the value obtained by dividing the difference value obtained by subtracting the compressor inlet pressure from the injection pressure by the difference value obtained by subtracting the compressor inlet pressure from the compressor discharge pressure is lower than the second predetermined value (i.e., when the condition is not satisfied), the controller 100 may decrease the opening of the first expansion valve 13 and terminate the control, at step S13.

While performing the above steps, when heating of the vehicle interior is required, the controller 100 may operate the normal heating mode for a preset time and then control the heat pump system so that the gas injection device 30 may be operated in the optimal condition.

Therefore, as described above, according to a control method of a heat pump system for a vehicle according to an exemplary embodiment of the present disclosure, when heating the vehicle interior by a heat pump system applied with the gas injection device 30, the performance and efficiency of the entire system may be improved by efficiently controlling the operation of the gas injection device 30 depending on conditions.

Furthermore, the present disclosure can reduce the air conditioning power consumption and increase the travel distance at the same time, by first performing the normal heating mode in which the gas injection device 30 is not operated, when heating the vehicle interior, and then performing the gas injection heating mode by determining whether the operation of the gas injection device 30 is possible.

Furthermore, according to the present disclosure, since the gas injection device 30 is controlled to operate only in the optimal condition when heating the vehicle interior, the liquid refrigerant remaining in the gas injection device 30 may be prevented from being introduced into the compressor 10 in advance, improving the durability and stability of the compressor 10.

While the present disclosure has been described in connection with what is presently considered to be practical exemplary embodiments of the present disclosure, it is to be understood that the disclosure is not limited to the disclosed embodiments. On the other hand, it is directed to cover various modifications and equivalent arrangements included within the spirit and scope of the appended claims.

### DESCRIPTION OF SYMBOLS

10: compressor
11: the refrigerant line
12: condenser
13: first expansion valve
14: evaporator
30: gas injection device
31: gas-liquid separator
32: second expansion valve
33: supply line
51: first pressure sensor
53: second pressure sensor
55: third pressure sensor
57: the refrigerant temperature sensor
60: the vehicle interior temperature sensor
70: discharge air temperature sensor
100: controller
110: data detecting unit

What is claimed is:

1. A control method of a heat pump system for a vehicle, the control method comprising:
operating, by a controller, a normal heating mode in response that a user operates a heat pump system for heating a vehicle interior;
determining, by the controller, whether an operation of a gas injection heating mode is possible based on data detected from a data detecting unit;
based on that the controller concludes that the operation of the gas injection heating mode is possible, operating, by the controller, the gas injection heating mode by operating a gas injection device;
checking, by the controller, a vehicle interior target temperature, and setting a target discharge air temperature based on the data detected from the data detecting unit;
determining, by the controller, whether a vehicle interior air discharge temperature is lower than the target discharge air temperature; and
increasing, by the controller, revolutions per minute (rpm) of a compressor, based on that the controller concludes that the vehicle interior air discharge temperature is lower than the target discharge air temperature.

2. The control method of claim 1, wherein in the determining of whether the operation of the gas injection heating mode is possible, the controller is further configured to perform:
determining whether a first condition that an ambient air temperature is higher than a predetermined temperature is satisfied; and
determine whether a second condition that a normal heating mode operation time is longer than a predetermined time is satisfied.

3. The control method of claim 2, wherein the controller is further configured to:
determine that the operation of the gas injection heating mode is possible based on that the first condition and the second condition are satisfied at the same time; and
determine that the operation of the gas injection heating mode is impossible based on that any one of the first condition and the second condition is not satisfied.

4. The control method of claim 1, wherein, in the determining of whether the operation of the gas injection heating mode is possible:
the controller is further configured to proceed back to perform the operating of the normal heating mode, based on that the controller concludes that the operation of the gas injection heating mode is impossible.

5. The control method of claim 1, wherein, in the determining of whether the vehicle interior air discharge temperature is lower than the target discharge air temperature:
the controller is further configured to perform the decreasing of the rpm of the compressor based on that the controller concludes that the vehicle interior air discharge temperature is higher than the target discharge air temperature.

6. The control method of claim 1, further comprising:
determining, by the controller, whether a compressor discharge pressure or a condenser discharge temperature is higher than a first predetermined value based on the data detected from the data detecting unit; and
increasing, by the controller, an opening of a second expansion valve based on that the controller concludes that the compressor discharge pressure or the condenser discharge temperature is higher than the first predetermined value.

7. The control method of claim 6, wherein, in the determining of whether the compressor discharge pressure or the condenser discharge temperature is higher than the first predetermined value,
the controller is further configured to perform the decreasing of the opening of the second expansion valve based on that the controller concludes that the compressor discharge pressure or the condenser discharge temperature is lower than the first predetermined value.

8. The control method of claim 6, further comprising:
determining, by the controller, whether a value obtained by dividing a difference value obtained by subtracting a compressor inlet pressure from an injection pressure by a difference value obtained by subtracting the compressor inlet pressure from the compressor discharge pressure is higher than a second predetermined value based on the data detected from the data detecting unit; and
increasing, by the controller, an opening of a first expansion valve and terminating a control, based on that the controller concludes that the value obtained by dividing a difference value obtained by subtracting the compressor inlet pressure from the injection pressure by the difference value obtained by subtracting the compressor inlet pressure from the compressor discharge pressure is higher than the second predetermined value.

9. The control method of claim 8, wherein, in the determining of whether a value obtained by dividing the difference value obtained by subtracting the compressor inlet pressure from the injection pressure by the difference value obtained by subtracting the compressor inlet pressure from the compressor discharge pressure is higher than the second predetermined value,
the controller is further configured to perform the decreasing the opening of the first expansion valve and terminate a control, based on that the controller concludes that the value obtained by dividing the difference value obtained by subtracting the compressor inlet pressure from the injection pressure by the difference value obtained by subtracting the compressor inlet pressure from the compressor discharge pressure is lower than the second predetermined value.

10. The control method of claim 1, wherein the data detecting unit comprises:
a first pressure sensor configured for measuring a pressure a refrigerant discharged from the compressor;
a second pressure sensor configured for measuring a pressure of the refrigerant introduced into the compressor;
a third pressure sensor configured for measuring a pressure of the refrigerant introduced from the gas injection device into the compressor;
a refrigerant temperature sensor configured for measuring a temperature of the refrigerant discharged from a condenser;
a vehicle interior temperature sensor configured for measuring a temperature of the vehicle interior; and
a discharge air temperature sensor configured for measuring a temperature of the air discharged into the vehicle interior.

11. The control method of claim 1, wherein the controller is electrically connected to the heat pump system, and the heat pump system comprises:
the compressor configured to compress an introduced refrigerant;
a condenser connected to the compressor through a refrigerant line, and configured to condense the introduced refrigerant;
a first expansion valve connected to the condenser through the refrigerant line, and configured to selectively expand the introduced refrigerant;
an evaporator connected to the first expansion valve through the refrigerant line, and configured to evaporate the introduced refrigerant; and
the gas injection device disposed on the refrigerant line between the condenser and the first expansion valve, and configured to selectively expand the refrigerant supplied from the condenser and flow the expanded refrigerant and selectively supply a partial refrigerant among the supplied refrigerant to the compressor to increase a flow rate of the refrigerant circulating the refrigerant line.

12. The control method of claim 11, wherein the gas injection device comprises:
a gas-liquid separator configured to separate an internally introduced refrigerant into a gaseous refrigerant and a liquid refrigerant and selectively discharge the separated refrigerant;
a second expansion valve disposed on the refrigerant line between the condenser and the gas-liquid separator, and configured to selectively expand the introduced refrigerant; and
a supply line connecting the compressor and the gas-liquid separator, and configured to selectively supply the gaseous refrigerant from the gas-liquid separator to the compressor.

13. A heat pump system comprising:
a compressor configured to compress an introduced refrigerant;
a condenser connected to the compressor through a refrigerant line, and configured to condense the introduced refrigerant;
a first expansion valve connected to the condenser through the refrigerant line, and configured to selectively expand the introduced refrigerant;
an evaporator connected to the first expansion valve through the refrigerant line, and configured to evaporate the introduced refrigerant;
a gas injection device including a gas-liquid separator and disposed on the refrigerant line between the condenser and the first expansion valve, and configured to selectively expand the refrigerant supplied from the condenser and flow the expanded refrigerant and selectively supply a partial refrigerant among the supplied refrigerant to the compressor to increase a flow rate of the refrigerant circulating the refrigerant line;
a supply line connecting the compressor and the gas-liquid separator; and
a controller including a processor and configured for:,
operating a normal heating mode in response that a user operates the heat pump system for heating a vehicle interior;
determining whether an operation of a gas injection heating mode is possible based on data detected from a data detecting unit;
based on that the controller concludes that the operation of the gas injection heating mode is possible, operating the gas injection heating mode by operating the gas injection device;
checking a vehicle interior target temperature, and setting a target discharge air temperature based on the data detected from the data detecting unit;
determining whether a vehicle interior air discharge temperature is lower than the target discharge air temperature; and
increasing revolutions per minute (rpm) of the compressor, based on that the controller concludes that the vehicle interior air discharge temperature is lower than the target discharge air temperature.

14. The heat pump system of claim 13, wherein in the determining of whether the operation of the gas injection heating mode is possible, the controller is further configured to perform:
determining whether a first condition that an ambient air temperature is higher than a predetermined temperature is satisfied; and
determine whether a second condition that a normal heating mode operation time is longer than a predetermined time is satisfied.

15. The heat pump system of claim 14, wherein the controller is further configured to:
determine that the operation of the gas injection heating mode is possible based on that the first condition and the second condition are satisfied at the same time; and
determine that the operation of the gas injection heating mode is impossible based on that any one of the first condition and the second condition is not satisfied.

16. The heat pump system of claim 13, wherein, in the determining of whether the operation of the gas injection heating mode is possible, the controller is further configured to proceed back to perform the operating of the normal heating mode, based on that the controller concludes that the operation of the gas injection heating mode is impossible.

17. The heat pump system of claim 13, wherein, in the determining of whether the vehicle interior air discharge temperature is lower than the target discharge air temperature, the controller is further configured to perform the decreasing of the rpm of the compressor based on that the controller concludes that the vehicle interior air discharge temperature is higher than the target discharge air temperature.

18. The heat pump system of claim 13, wherein the controller is further configured to:
determine whether a compressor discharge pressure or a condenser discharge temperature is higher than a first predetermined value based on the data detected from the data detecting unit; and
increase an opening of a second expansion valve based on that the controller concludes that the compressor discharge pressure or the condenser discharge temperature is higher than the first predetermined value.

19. The heat pump system of claim 18, wherein, in the determining of whether the compressor discharge pressure or the condenser discharge temperature is higher than the first predetermined value, the controller is further configured to perform the decreasing of the opening of the second expansion valve based on that the controller concludes that the compressor discharge pressure or the condenser discharge temperature is lower than the first predetermined value.

20. The heat pump system of claim 18, wherein the controller is further configured to:
determine whether a value obtained by dividing a difference value obtained by subtracting a compressor inlet pressure from an injection pressure by a difference value obtained by subtracting the compressor inlet pressure from the compressor discharge pressure is higher than a second predetermined value based on the data detected from the data detecting unit; and
increase an opening of a first expansion valve and terminating a control, based on that the controller concludes that the value obtained by dividing a difference value obtained by subtracting the compressor inlet pressure from the injection pressure by the difference value obtained by subtracting the compressor inlet pressure from the compressor discharge pressure is higher than the second predetermined value, and
decrease the opening of the first expansion valve and terminate a control, based on that the controller concludes that the value obtained by dividing the difference value obtained by subtracting the compressor inlet pressure from the injection pressure by the difference value obtained by subtracting the compressor inlet pressure from the compressor discharge pressure is lower than the second predetermined value.
